(19) United States
(12) Patent Application Publication
(10) Pub. No.: US 2007/0263301 A1
(43) Pub. Date: Nov. 15, 2007

(54) System and Method for Automatic Adjustment of Mirrors for a Vehicle

(76) Inventor: Zohar Agrest, Ganei Tikva (IL)

Correspondence Address: LOWE HAUPTMAN HAM & BERNER, LLP, 1700 DIAGONAL ROAD, SUITE 300, ALEXANDRIA, VA, 22314, US

(21) Appl. No.: 10/561,263

(22) PCT Filed: Jun. 17, 2004
(86) PCT No.: PCT/IL04/00523

§ 371 Date: Mar. 9, 2007

(51) Int. Cl. B60R 1/02

(52) U.S. Cl. 359/843

(57) ABSTRACT

An automatic mirror position adjustment system (100) and method for a vehicle is provided, enabling the position of one or more rear-view mirrors (82, 84, 86) to be automatically adjusted in response to the rotational motions of the vehicle about two or three orthogonal axes, to provide improved fields of view to the driver of the vehicle. A turning sensor (50) is mounted to the vehicle generates input signals responsive to a rotation of the vehicle about at least two orthogonal axes. A control unit (60) generates output signals responsive to these input signals. A driving mechanism (70) coupled to each mirror rotates the mirror about the orthogonal axes in response to the output signals. A feature is also provided for panning the mirrors about at least one axis to provide a visual scan of an effectively expanded field of view for a driver of the vehicle.

### FIELD OF THE INVENTION

This invention relates to a system and method for the automated adjustment of mirrors of a vehicle controlled according to predetermined criteria. In particular, the invention is concerned with providing a useful rear view to the user in a vehicle that is adaptable to changing road conditions such as road bends and inclines, and to traffic conditions in procedures such as overtaking, for example.

### BACKGROUND OF THE INVENTION

Rear view mirrors are useful devices in road vehicles that enable the driver to view part of the scenery behind the vehicle without having to turn the head away from the forward direction in which the vehicle is traveling. Such devices are well known and find universal use for licenced road vehicles, improving road safety by enabling the user to maintain the forward scenery in substantially main view all the time, while diverting just the focus of attention to the rear scenery viewed from one or more rear mirrors. Accordingly, should the traffic or road conditions change ahead of the vehicle, the driver may take account of what is happening behind the vehicle without using precious time turning the head, and without losing sight of what is continuing to develop in front of the vehicle.

In land vehicles such as cars, lorries, trucks and the like, external mirrors are commonly mounted onto the right and left sides of the vehicle, and another mirror is internally mounted in the vehicle, and the mirrors are angled to provide the driver with a rearwards view of the scenery from the different vantage points. Planar mirrors provide non-distorted views, and have been largely superceded by convex mirrors of moderate curvature, which provide a relatively wider field of view, with only a modest amount of distortion. Rear view mirrors on the driver's side provide the user with a field of view of about 15°, typically, while the passenger side mirror may provide a much reduced field of view, and the interior centrally mounted rear mirror typically provides a filed of view of about 15°-20°. Thus each rear view mirror only provides a field of view that is a portion of the total rear scenery, and when taken together there are still portions of the scenery that remain missing, and are often referred to as “blind spots”. While mirrors of higher curvature provide a wider field of view, this is at the expense of substantial distortion, in which detail and depth perception are diminished considerably. Ideally only a full 180° field of view from the driver's position enables the driver to be filly aware of the traffic and road situation rearwards of the driver of the vehicle. However, when driving along a straight and level direction, the usual combination of rear view mirrors are often sufficient for periodically checking the status of road/traffic conditions at the rear of the vehicle.

A problem arises when the vehicle turns into a curve, incline or a bank. While the angular disposition of the mirrors with respect to the vehicle and driver remain unchanged, the road behind the vehicle is no longer in the same relative position that it was when driving straight and level. Accordingly, the part of the scenery available for viewing via the rear mirrors is offset relative to the road immediately behind the vehicle, and creates blind spots for the driver, who then needs to turn his/her head to check this part of the scenery. For articulated trucks and buses, the line of sight provided by the external mirrors is further limited due to the bending of the vehicle. Thus, accidents can often happen when vehicles are turning and other vehicles, bicycles or pedestrians are not seen by the driver because they are in the blind spot at that moment.

A similar problem arises when a driver wishes to overtake another vehicle that is traveling ahead or simply change lane. The internal mirror only provides a direct rear view of the scenery, while the side mirrors each tend to capture an angled view of the rear-side scenery. It often happens that another vehicle may be overtaking the present vehicle, and is situated at a relative position with respect thereto that is ahead of the field of view of the side mirror, but still behind the position of the driver. In this position, the driver cannot see the overtaking car, and if he/she should attempt to overtake another car, a collision may occur. Accordingly, as a precaution, many drivers turn their heads to check the full field of view on the side they wish to overtake before doing so. However, this means that for a time the driver is not looking in the forwards direction, and this in itself could be dangerous, as already discussed.

Thus, the partial views provided by the mirrors result in blind spots, which if ignored may lead to accidents, and on the other hand if the driver turns his/her head to check the part of the road corresponding to the blind spots, this may also lead to accidents.

Systems are known in which an external side mirror in the inside of a curve adjusts itself automatically to correspond to the turning motion of a large articulated vehicle in a curve, so that the visible area is maintained with respect to the entire length of the vehicle. For example, in U.S. Pat. No. 3,761,164, a mirror assembly for trucks or the like is mechanically connected to and actuated in response to movement of the steering wheel, so that the mirror is automatically moved to a different position according to the position of the steering wheel.

In U.S. Pat. No. 5,719,713 an automatic side view mirror tracking and control system enables drivers of articulated vehicles such as tractor trailers to keep visual contact with the side and rear of the trailer throughout a turn while backing the vehicle. The turning differential in distance between the tractor and the trailer is determined by means of ultrasonic sensors, and as the angle between the tractor and the trailer is changed, a signal to cause the mirror to track the inside curve is achieved. Similar systems based on ultrasonic sensors are disclosed in U.S. Pat. No. 5,306,953 and U.S. Pat. No. 5,132,851. U.S. Pat. No. 5,719,713 also discloses the installation of a magnetic field sensor on the tractor as well as on the trailer, and from the difference in signals from the two sensors, a signal for the turning of the vehicle around its vertical axis is arrived at. However, both sensors are influenced by the magnetic field of the earth, as well as the magnetic fields generated by the multitude of electrical operators in the vehicle.

In U.S. Pat. No. 6,390,631, a system is disclosed for the automatically adjusting the exterior rear view mirror when turning for motor vehicles with trailers. The system is based on a gyroscopic-type sensor for the detection of turning of the vehicle about a vertical axis, and is used for enabling the tracking of the external mirror corresponding to the turning of the vehicle about its vertical axis.

The above references are incorporated herein in their entirety.

Aircraft are also often fitted with rear view mirrors, in large aircraft these are used for taxing, and in smaller aircraft including military aircraft rear-view mirrors are sometime used in flight. Sea vessels are also sometimes fitted with rear view mirrors. In all such cases, where the mirrors are fixedly mounted to the vehicle, the field of view covered by the mirror when the vehicle is turning about any axis is usually unsatisfactory.

### SUMMARY OF THE INVENTION

The present invention is directed to systems and methods for automatically adjusting mirrors of a vehicle.

In the first embodiment of the invention, an automatic mirror position adjustment system for a vehicle is provided, comprising:

at least one mirror movably mountable to said vehicle;

a turning sensor mountable to said vehicle and adapted for generating input signals responsive to rotations of said vehicle about at least two orthogonal axes;

a control unit operatively connected to said turning sensor and adapted for generating output signals responsive to said input signals;

a driving mechanism operatively connected to said control unit and coupled to the or each said at least one mirror for rotating the or each mirror about said at least two orthogonal axes in response to said output signals.

The turning sensor is adapted for generating input signals responsive to yawing and pitching rotations of said vehicle, or to yawing and rolling rotations of said vehicle, or to rolling and pitching rotations of said vehicle, or indeed to all three yawing, pitching and rolling rotations of said vehicle. The turning sensor comprises any suitable arrangement that provides rotational data of the vehicle about at least two, and preferably three orthogonal axes. The turning sensor may be gyroscope-based, for example, and include any one of a mechanical gyroscope, laser gyroscope and optical gyroscope. Alternatively, the turning sensor comprises a accelerometer arrangement capable of measuring accelerations of said vehicle in said at least two axes coupled to an angular rate sensor arrangement capable of measuring rotation rate of said vehicle in said at least two axes. Such an accelerometer arrangement is capable of measuring accelerations of said vehicle in three orthogonal axes including said at least two axes and the angular rate sensor is capable of measuring angular rate of said vehicle in three orthogonal axes including said at least two axes. This arrangement further comprises processing means for integrating angular rate about each axis provided by said angular rate sensor to provide raw angles about each axis, and for inferring tilt angle about each axis from acceleration measurements provided by said accelerometer arrangement, and for forcing the raw angles to match the tilt angles for each axis over a predetermined time period. Such a processing means may be comprised in said control unit, or alternatively comprise a digital signal processor.

Typically, a separate driving mechanism is provided for each rear-view mirror, and each driving mechanism is adapted for rotating the corresponding mirror at least about said at least two axes, and preferably about three orthogonal axes including said at least two axes. Typically, the driving mechanism comprises a motor arrangement for rotating the corresponding mirror about the two or three orthogonal axes.

The control unit typically comprises a microprocessor unit, and is adapted for providing the said output signals according to predetermined criteria. Typically, the control unit provides said output signals to said driving mechanism such that said driving mechanism provides a rotation to said corresponding mirror about each said axis in directions opposed to the rotation of the said vehicle about each said axis, respectively. Optionally, the control unit is adapted for providing output signals to said driving mechanism for returning said at least one mirror to a default position that provides optimal fields of view to a driver of the vehicle when the vehicle is traveling along a straight and level path.

The control unit is adapted for providing output signals to said driving mechanism for yawing said at least one mirror to a position that provides optimal fields of view to a driver of the vehicle when the vehicle is traveling along a curved path. Optionally, the control unit is adapted for maintaining a yaw angle between said at least one mirror and said vehicle substantially constant when said vehicle is traveling along a curved path of substantially constant curvature.

The control unit is adapted for providing output signals to said driving mechanism for pitching said at least one mirror to a position that provides optimal fields of view to a driver of the vehicle when the vehicle is traveling along an inclined path. Optionally, the control unit is adapted for maintaining a pitch angle between said at least one mirror and said vehicle substantially constant when said vehicle is traveling along an inclined path of substantially constant gradient. Typically, the constant pitch angle relative to said vehicle is substantially similar to a pitch angle of said at least one mirror at a default position thereof that provides optimal fields of view to a driver of the vehicle when the vehicle is traveling along a straight and level path.

The control unit is adapted for providing output signals to said driving mechanism for rolling said at least one mirror to a position that provides optimal fields of view to a driver of the vehicle when the vehicle is traveling along a banked path. Optionally, the control unit is adapted for maintaining a roll angle between said at least one mirror and said vehicle substantially constant when said vehicle is traveling along a banked path of substantially constant gradient. Optionally, the constant roll angle relative to said vehicle is substantially similar to a roll angle of said at least one mirror at a default position thereof that provides optimal fields of view to a driver of the vehicle when the vehicle is traveling along a straight and level path.

Preferably, the system further comprises an interface unit operatively connected to said control unit. The interface unit is optionally configured for instructing said control unit to provide output signals to said driving mechanism for returning said at least one mirror to a default position that provides optimal fields of view to a driver of the vehicle when the vehicle is traveling along a straight and level path. Additionally, the interface unit may be further adapted for setting and storing said default positions for a plurality of users. The interface unit may also be adapted for enabling a user to selectively activate or deactivate said system. Optionally, when the user deactivates the system, the interface unit may be adapted for instructing said control unit to provide output signals to said driving mechanism for returning said at least one mirror to a default position that provides optimal fields of view to a driver of the vehicle when the vehicle is traveling along a straight and level path, when said system is deactivated.

Optionally, the control unit may be further adapted for selectively providing output signals responsive to a predetermined input, wherein said driving mechanism to pan the or each mirror through a predetermined angular path about said at least one said axis in response to said output signals. The angular path typically provides a yawing rotation to at least one mirror, and is useful for overtaking maneuvers, or for simply changing lanes, for example. It is also possible for the angular path to provide a pitching or rolling rotation, or indeed any combination, simultaneously or serially, about the three orthogonal axes. Preferably, the angular path is configured to provide a visual scan of an effectively expanded field of view for a driver of said vehicle via a corresponding said mirror. This path typically includes a rotation of a corresponding said mirror inboard towards said vehicle and outboard away from said vehicle.

The predetermined input may be provided in any suitable manner, for example, via the interface unit operatively connected to said control unit, or by an indicator circuit operatively connected to said control unit.

Typically, the system is used in conjunction with, and comprises, a first rear view mirror internally mounted in said vehicle, a second rear view mirror externally mounted to a right side of said vehicle, and a third rear view mirror externally mounted to a left side of said vehicle.

In a second embodiment, an automatic mirror adjustment system for a vehicle is provided similar to that of the first embodiment, mutatis mutandis, but the system is directed to a single mirror and may be accommodated in a suitable housing, enabling the separate stand-alone systems to be mounted to the vehicle at each mirror location. This embodiment has retrofit potential for existing vehicles.

A third embodiment of the invention is directed to an independent automatic mirror panning system for a vehicle, comprising:

at least one mirror movably mountable to said vehicle;

a control unit adapted for generating output signals responsive to a predetermined input signal;

a driving mechanism operatively connected to said control unit and coupled to the or each said at least one mirror for panning the or each mirror through a predetermined angular path about said at least one axis in response to said output signals.

The angular path typically provides a yawing rotation to at least one mirror, and is useful for overtaking maneuvers, or for simply changing lanes, for example. It is also possible for the angular path to provide a pitching or rolling rotation, or indeed any combination, simultaneously or serially, about the three orthogonal axes. Preferably, the angular path is configured to provide a visual scan of an effectively expanded field of view for a driver of said vehicle via a corresponding said mirror. This path typically includes a rotation of a corresponding said mirror inboard towards said vehicle and outboard away from said vehicle.

The driving mechanism comprises a motor arrangement for rotating the corresponding said mirror about at least said one axis.

The control unit comprises a microprocessor unit, and the predetermined input may be provided in any suitable manner, including via an interface unit operatively connected to said control unit, or by an indicator circuit operatively connected to said control unit, for example. The interface unit may be adapted for enabling a user to selectively activate or deactivate said system. When deactivating the system, the interface unit may be adapted for instructing said control unit to provide output signals to said driving mechanism for returning said at least one mirror to a default position that provides optimal fields of view to a driver of the vehicle when the vehicle is traveling along a straight and level path, when said system is deactivated.

Typically, the system is used in conjunction with, and comprises, a first rear view mirror internally mounted in said vehicle, a second rear view mirror externally mounted to a right side of said vehicle, and a third rear view mirror externally mounted to a left side of said vehicle.

In a fourth embodiment, an automatic mirror panning system for a vehicle is provided similar to that of the second embodiment, mutatis mutandis, but directed to a single mirror, and the system may be accommodated in a suitable housing, enabling the separate stand-alone systems to be mounted to the vehicle at each mirror location. This embodiment has retrofit potential for existing vehicles.

The present invention is also directed to an automatic mirror position adjustment method for a vehicle, comprising:

providing at least one mirror movably mountable to said vehicle;

sensing rotation of said vehicle about at least two orthogonal axes and generating input signals responsive to said rotation;

generating output signals responsive to said input signals;

rotating the or each mirror about said at least two orthogonal axes in response to said output signals.

The input signals are generated in responsive to yawing and pitching rotations of said vehicle, or to yawing and rolling rotations of said vehicle, or to rolling and pitching rotations of said vehicle, or indeed to all three yawing, pitching and rolling rotations of said vehicle.

The rotation may be sensed in any suitable manner, for example via a suitable gyroscope, such as for example any one of a mechanical gyroscope, laser gyroscope and optical gyroscope. Alternatively, the rotation may be sensed via an accelerometer arrangement capable of measuring accelerations of said vehicle in said at least two axes coupled to an angular rate sensor arrangement capable of measuring rotation rate of said vehicle in said at least two axes. Such an accelerometer arrangement measures accelerations of said vehicle in three orthogonal axes including said at least two axes. The angular rate sensor measures angular rate of said vehicle in three orthogonal axes including said at least two axes. The method further comprises the step of integrating angular rate about each axis provided by said angular rate sensor to provide raw angles about each axis, and inferring tilt angle about each axis from acceleration measurements provided by said accelerometer arrangement, and forcing the raw angles to match the tilt angles for each axis over a predetermined time period.

The method optionally comprises the step of rotating the or each mirror about in three orthogonal axes including said at least two axes.

The output signals are provided according to predetermined criteria. For example, each mirror is rotated about each said axis in a direction opposed to the rotation of the said vehicle about each corresponding said axis, responsive to said output signals. Optionally, the output signals for returning said at least one mirror to a default position that provides optimal fields of view to a driver of the vehicle when the vehicle is traveling along a straight and level path.

Optionally, at least one mirror is yawed to a position that provides optimal fields of view to a driver of the vehicle when the vehicle is traveling along a curved path in response to said output signals. A yaw angle between said at least one mirror and said vehicle is maintained substantially constant when said vehicle is traveling along a curved path of substantially constant curvature.

Optionally, at least one mirror is pitched to a position that provides optimal fields of view to a driver of the vehicle when the vehicle is traveling along an inclined path in response to said output signals. A pitch angle between said at least one mirror and said vehicle is maintained substantially constant when said vehicle is traveling along an inclined path of substantially constant gradient. The constant pitch angle relative to said vehicle may be substantially similar to a pitch angle of said at least one mirror at a default position thereof that provides optimal fields of view to a driver of the vehicle when the vehicle is traveling along a straight and level path.

Optionally, at least one mirror is rolled to a position that provides optimal fields of view to a driver of the vehicle when the vehicle is traveling along a banked path in response to said output signals. A roll angle between said at least one mirror and said vehicle is maintained substantially constant when said vehicle is traveling along a banked path of substantially constant gradient. The constant roll angle relative to said vehicle may be substantially similar to a roll angle of said at least one mirror at a default position thereof that provides optimal fields of view to a driver of the vehicle when the vehicle is traveling along a straight and level path.

The method may further comprise the step of providing output signals for returning said at least one mirror to a default position that provides optimal fields of view to a driver of the vehicle when the vehicle is traveling along a straight and level path.

The method may further comprise the step of setting and storing said default positions for a plurality of users.

The method may further comprise selectively providing output signals responsive to a predetermined input, wherein the or each mirror is panned through a predetermined angular path about said at least one said axis in response to said output signals. The angular path preferably provides a yawing rotation to said at least one mirror, though rolling or pitching rotations, or any simultaneous or serial combination of rotations may be provided. Preferably, the angular path provides a visual scan of an effectively expanded field of view for a driver of said vehicle via a corresponding said mirror. Typically, the angular path includes a rotation of a corresponding said mirror inboard towards said vehicle and outboard away from said vehicle.

The predetermined input may be provided by any suitable means, for example, via an interface unit operatively connected to a control unit, or by an indicator circuit operatively connected to the control unit.

The present invention is also directed to an automatic mirror panning method for a vehicle, comprising:

at least one mirror movably mountable to said vehicle;

generating output signals responsive to a predetermined input signal;

panning the or each mirror through a predetermined angular path about said at least one axis in response to said output signals.

The angular path preferably provides a yawing rotation to said at least one mirror, though rolling or pitching rotations, or any simultaneous or serial combination of rotations may be provided. Preferably, the angular path provides a visual scan of an effectively expanded field of view for a driver of said vehicle via a corresponding said mirror. Typically, the angular path includes a rotation of a corresponding said mirror inboard towards said vehicle and outboard away from said vehicle.

The predetermined input may be provided by any suitable means, for example, via an interface unit operatively connected to a control unit, or by an indicator circuit operatively connected to the control unit.

The method may further comprise the step of providing output signals to a driving mechanism operatively connected to said at least one mirror for returning said at least one mirror to a default position that provides optimal fields of view to a driver of the vehicle when the vehicle is traveling along a straight and level path, when said panning is terminated.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an isometric view of an orthogonal coordinate axes system used to define rotational motion of an exemplary vehicle.

FIG. 2 schematically illustrates components of the first embodiment of the invention.

FIG. 3 schematically illustrates in plan view the relative positions of various vehicles traveling along a rectilinear path.

FIG. 4 schematically illustrates the relative positions of the vehicles of FIG. 3 traveling in a curve, and the fields of view provided by static mirrors for one of the vehicles.

FIG. 5 schematically illustrates the relative positions of the vehicles in FIG. 4, and the adjustment of the fields of view provided by the embodiment of FIG. 2.

FIG. 6 schematically illustrates in side view the relative positions of various vehicles traveling along a rectilinear path.

FIG. 7 schematically illustrates the relative positions of the vehicles of FIG. 6 traveling with respect to an incline a curve, and the fields of view provided by a static mirror for one of the vehicles.

FIG. 8 schematically illustrates the relative positions of the vehicles in FIG. 7, and the adjustment of the field of view provided by the embodiment of FIG. 2.

FIG. 9 schematically illustrates in rear view the position of a vehicle traveling along a level path.

FIG. 10 schematically illustrates the position of the vehicle of FIG. 9 traveling along a banked path, and the fields of view provided by static mirrors for the vehicles.

FIG. 11 schematically illustrates the position of the vehicle in FIG. 10, and the adjustment of the fields of view provided by the embodiment of FIG. 2.

FIG. 12 schematically illustrates components of the first embodiment of the invention.

FIG. 13 schematically illustrates in plan view the relative positions of various vehicles traveling along a rectilinear path.

FIG. 14 schematically illustrates the relative positions of the vehicles in FIG. 13, and the adjustment of the fields of view provided by the scanning feature of the embodiment of FIG. 2.

FIG. 15 schematically illustrates components of the third embodiment of the invention.

FIG. 16 schematically illustrates components of the fourth embodiment of the invention.

### DETAILED DESCRIPTION OF THE INVENTION

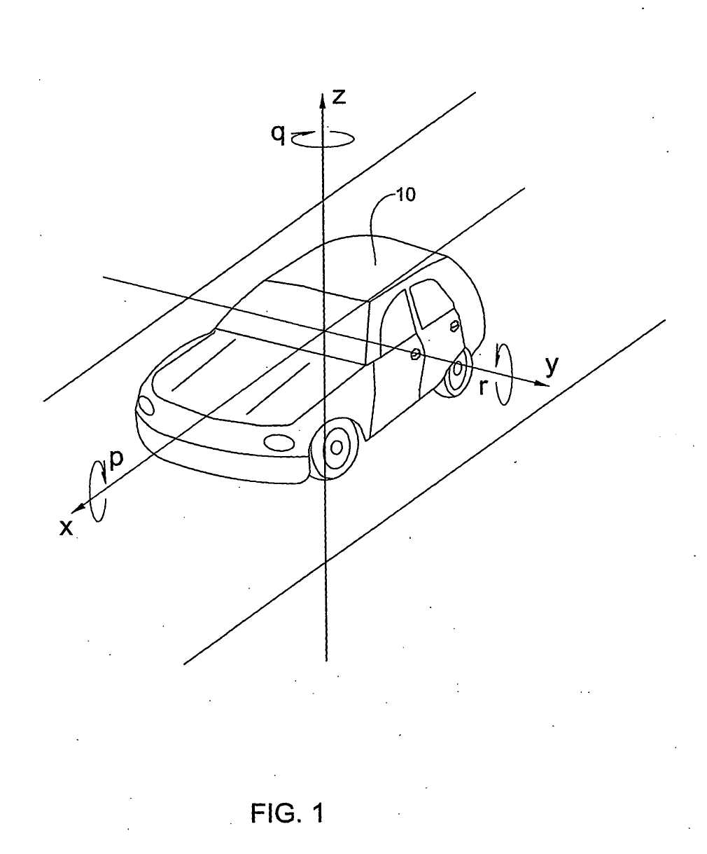

FIG. 1 illustrates a typical orthogonal coordinate axes system with respect to which it is convenient to describe the motion of a vehicle 10. The longitudinal direction (x-direction) is defined as the general forwards direction of the vehicle, the transverse direction (y-direction) as the sideways movement of the vehicle. The third direction is orthogonal to the other two directions, and is along the z-axis, commonly referred to the vertical axis. Rotations of the vehicle can occur about any one or a combination of these axes: roll, p, about the x-axis; pitch, q, about the y-axis; and yaw, q, about the z-axis.

The motion of a vehicle generally includes one or a combination of translations along and rotations about one or more of the axes. In land vehicles, the rotations mainly comprise yawing when the vehicle is turning into a curve, pitching when the vehicle is turning into an incline, and rolling when traveling along a banking surface. Roll may also play a greater part in the motion of some surface vehicles, such as hovercraft and all-terrain vehicles, and also for sea-faring vehicles. All three motions are important for aircraft.

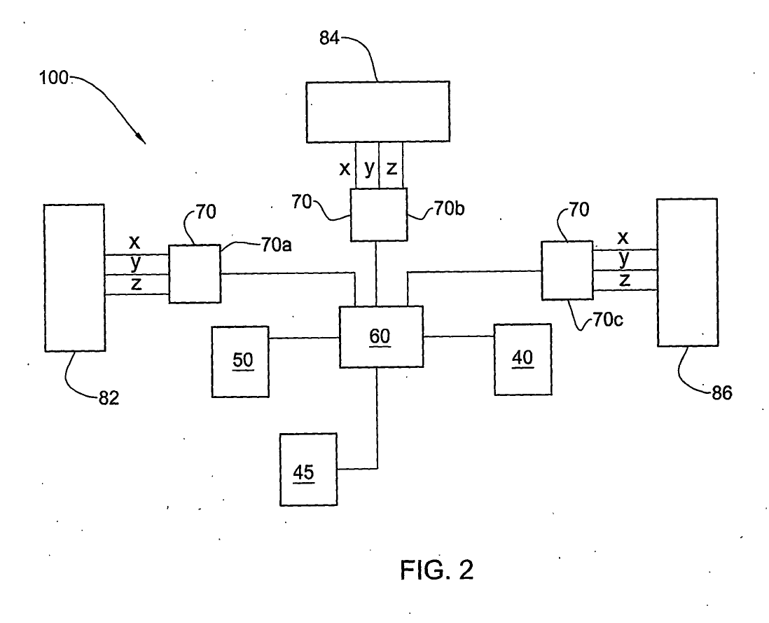

Referring to FIG. 2 a first embodiment of the system, generally designated 100, comprises a turning sensor 50, a control unit 60, and mirror driving mechanism or other driving means 70, and is directed at providing automatic adjustments to the position of one or more mirrors of the vehicle in response to changes in the vehicles attitude in terms or pitch, roll and/or yaw. The various electrically driven components of the system 100 are electrically connected to the vehicle's electrical power supply (not shown), and may optionally further comprise a back up supply such as batteries to preserve data particularly in the control unit 60 should there be an interruption of electrical power from the vehicle.

Typically, a vehicle 10 fitted with the present invention comprises three mirrors which are movably mounted to the vehicle: a left side or driver's side mirror 82, a right side or passenger side mirror 86, and an internally mid-mounted mirror 84.

The present embodiment is described with respect to a land vehicle 10 such as a car, van, truck, bus, articulated vehicles such as tow trucks and tractor trailers. However, it also applies to other land vehicles such as motorcycles, tanks and other military vehicles; sea faring vehicles; hybrid vehicles such as hovercraft; and airborne vehicles, mutatis mutandis.

In this embodiment, separate the mirror driving means 70, typically in the form of adjustment devices and herein designated 70a, 70b, 70c respectively, are provided one for each mirror 82, 84, 86, respectively. In right-hand cars, the driver's side mirror 82 is on the right, and the passenger side mirror 86 is on the right. In some vehicles, the central mirror may be externally mounted. In other embodiments, only one or two, or more than three rear-view mirrors may be provided for the vehicle, and at least one of the said rear view mirrors is operatively connected to a dedicated mirror driving means 70. Thus, while preferably all the rear view mirrors mounted on the vehicle 10 are adjustable by means of the corresponding mirror driving means 70, it is also possible for some of the mirrors to be statically mounted.

Referring to FIG. 2, each mirror driving means 70a, 70b, 70c comprises a suitable actuator, typically one or a set of motors, which are operatively connected to the corresponding mirror 82, 84, 86 respectively. The actuators for each mirror driving means are capable in each case of providing independent rotation of the mirror about the x and/or y and/or z axes in response to suitable signals provided by the control unit 60. Optionally, the actuators may be step motors, or alternatively DC motors may be used, which typically maintain a holding torque when the DC voltage is turned off, in conjunction with suitable reduction gears.

The turning sensor 50 is configured to determine the changes in component rotational angles p, q, r, of the vehicle each with respect to a respective reference datum of the vehicle, and to convert these changes into corresponding signals that are input to the control unit 60. The control unit 60 then, based on these input signals, provides output signals which are conveyed to each of the mirror driving means 70a, 70b, 70c to adjust the angles of each of the mirrors 82, 84, 86, respectively, with respect to one or more of axes x, y, z of the vehicle 10 to provide optimal optical fields of view for the driver.

The aforementioned reference datums are typically set at zero when the vehicle is horizontal and traveling in a direction along the x-axis, i.e., in a direction aligned with the longitudinal axis of the vehicle, and when there is zero roll, pitch or yaw. In this condition, herein referred to as the default position of the mirrors, the mirrors 82, 84 and 86 are set such as to provide the optimum fields of view for the driver, as will be further described below.

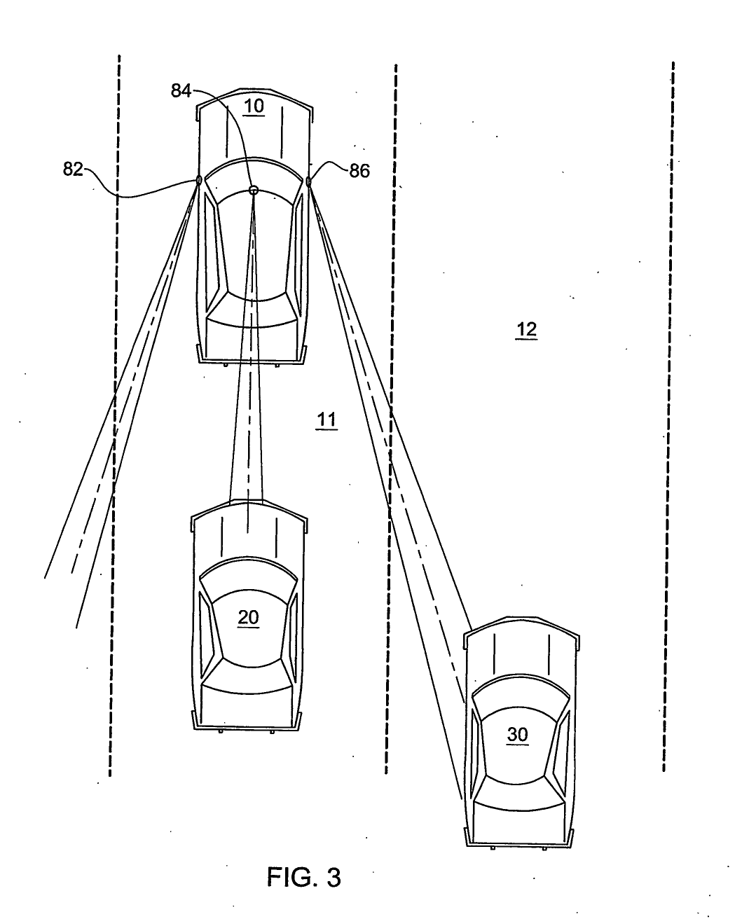

FIGS. 3 to 5 illustrate operation of the system 100 with reference to yawing turns about the z-axis, when there is no turning of the vehicle about the other two axes.

FIG. 3 illustrates the vehicle 10 traveling along a straight level road lane 11, trailed directly behind by another vehicle 20, and by a second vehicle 30 on the right hand lane 12. The mirrors 82, 84, 86 are set up in the default positions such as to provide a reasonable filed of view of the rear of the vehicle 10, so that the central mirror 84 captures the trailing vehicle 20, and the right hand mirror 86 captures the trailing vehicle 30 on the right hand lane.

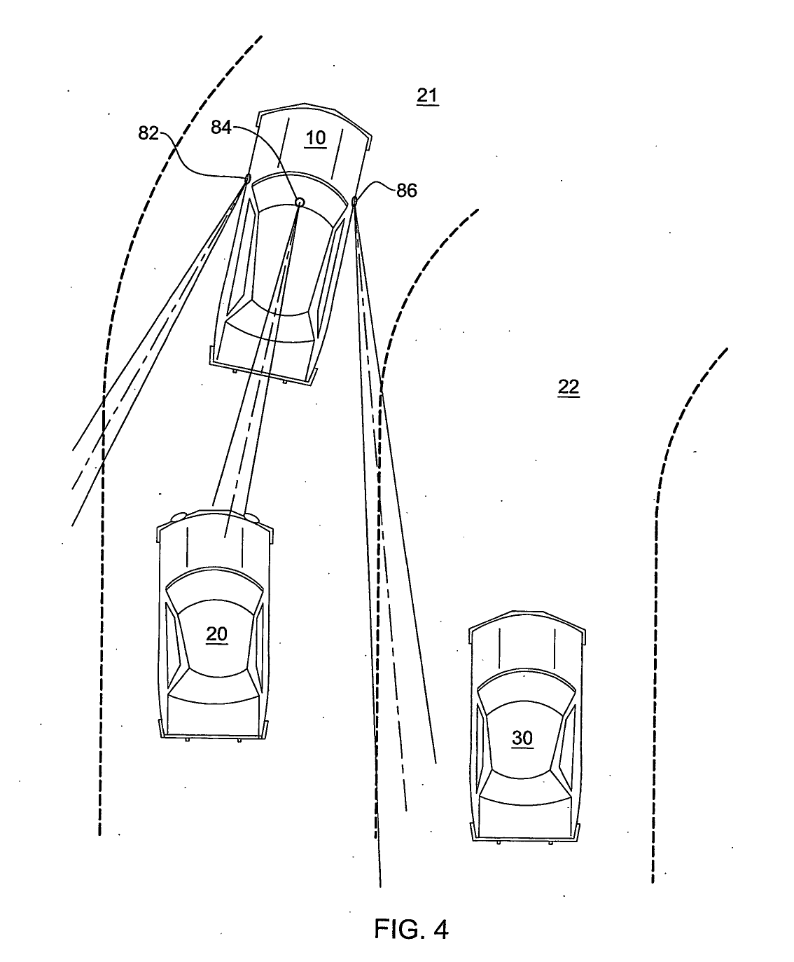

As illustrated in FIG. 4, as vehicle 10 turns in curve 21, if the positions of the mirrors relative to the vehicle 10 are maintained statically, i.e. in the default positions, the field of view provided by the right hand mirror 86 completely misses the trailing vehicle 30 on the right hand lane 22.

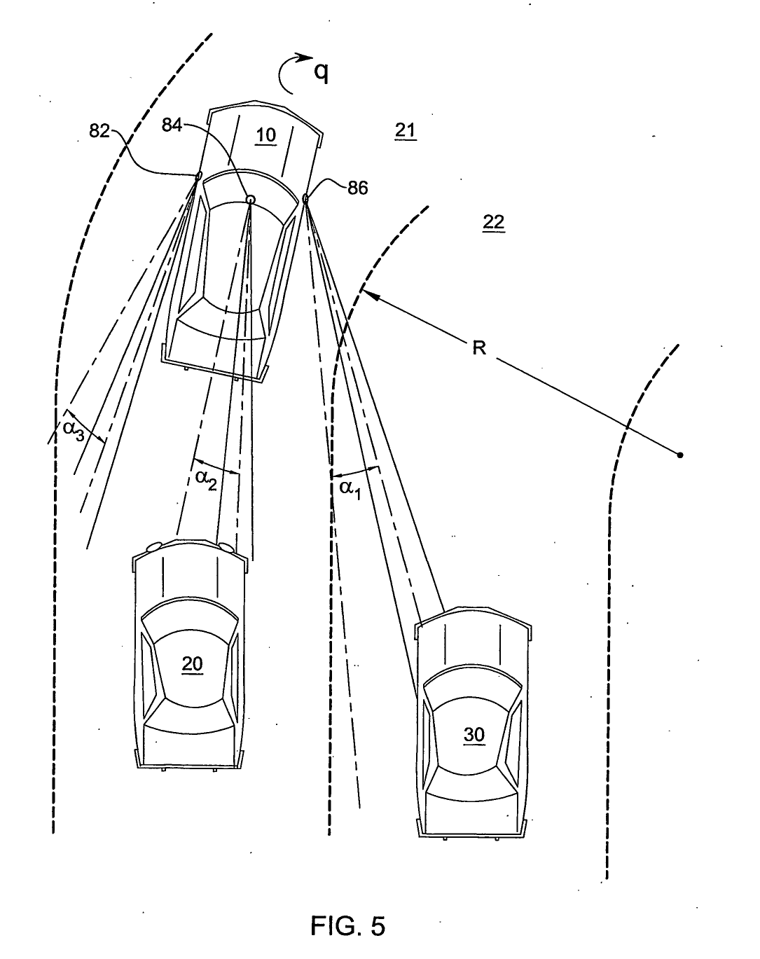

Referring to FIG. 5, according to the present invention, as the vehicle 10 turns into curved lane 21, the vehicle 10 experiences a yaw q about the z-axis, which is detected by the turning sensor 50, and corresponding input signals are sent to the control unit 60. In turn, the control unit 60 provides appropriate output control signals to the mirror driving means 70c to actuate the right side mirror 86 and rotate the same about the z-axis to shift the field of view by an angle α1, thus compensating for the rotation of the vehicle 10 due to the curvature of the lane 21. This procedure enables the trailing vehicle 30 on the right lane 22 to once again fall in the field of view of the right hand mirror 86. Thus, the turning angle al of the mirror 86 is dependent on the curvature R of the lane 21, or rather of the curved path taken by the vehicle 10; the greater the curvature, the more the mirror 86 is rotated about the z-axis. Similarly, the control unit 60 also provides suitable output signals to operate the central mirror 84 which is also angularly displaced by an angle α2, providing a more central view of the trailing vehicle 20. The control unit 60 can also provide suitable output signals to the left side mirror 82, which can also be operated to rotate about the z-axis by angle α3. Thus, as the vehicle 10 effectively rotates a rotation q about its z-axis while it is traveling along the lane 21, the mirrors 82, 84, 86 are also appropriately rotated to maintain the relative viewing angles for the driver as was the case before the turning commenced.

If the vehicle stays traveling along a path of substantially constant curvature, then, while the vehicle is continually rotating about the z-axis as it follows this path, the rotation of the vehicle 10 relative to its local coordinate system x, y, z will in fact be zero, and the mirrors typically remain locked in the positions illustrated in FIG. 5. However, should the path taken by the vehicle change in curvature, which may include going from a positive curvature to a negative curvature such as for example when traveling along a winding road, the turning sensor 50 will once again sense the change in the attitude of the vehicle with respect to the z-axis. Appropriate signals are once again sent to the mirror driving means 70a, 70b, 70c, to change rotate the mirrors 82, 84, 86 respectively about the z-axis in an appropriate manner. Further, when the vehicle reverts to a rectilinear path, the mirror driving means 70a, 70b, 70c, actuate the mirrors to return each to its default position on receiving the appropriate output signals form the control unit 60.

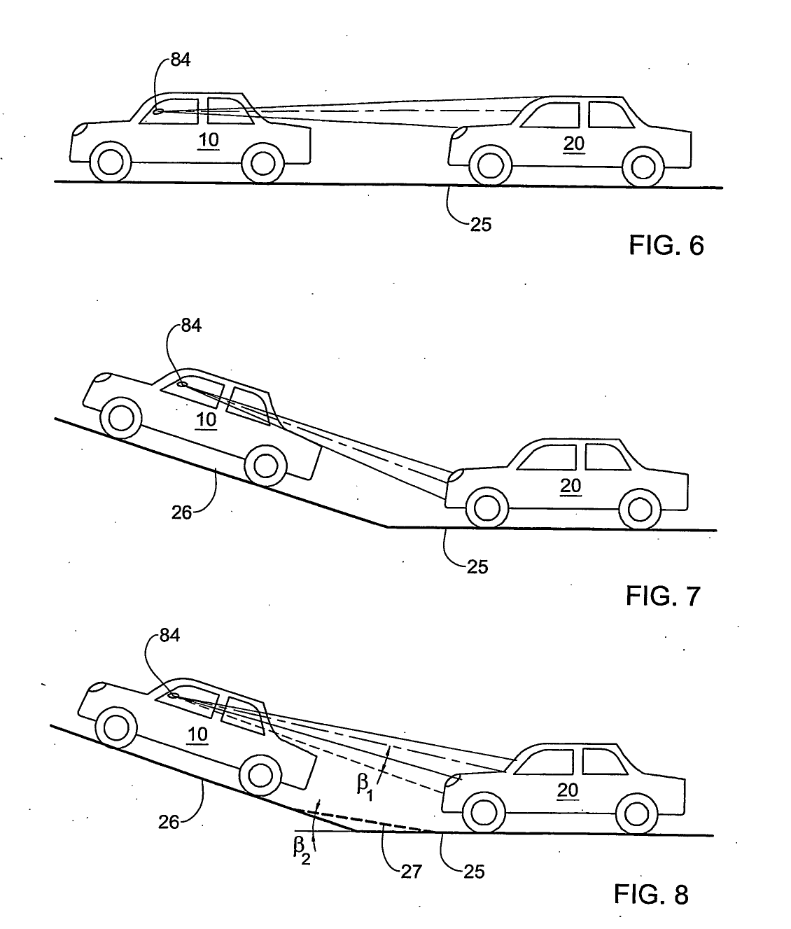

FIGS. 6 to 8 illustrate operation of the system 100 with reference to pitching turns about the y-axis when there is no turning of the vehicle about the other two axes.

FIG. 6 illustrates the vehicle 10 traveling along a level road lane 25, trailed directly behind by another vehicle 20. The central mirror 84, and the side mirrors (not shown) are set up-in the default positions such as to provide a reasonable field of view of the rear of the vehicle 10, so that at least the central mirror 84 captures the main body of trailing vehicle 20, in particular the front windscreen thereof and preferably also the indicators thereof.

As illustrated in FIG. 7, as vehicle 10 turns in into upward incline 26, if the positions of the mirrors relative to the vehicle 10 are maintained statically, i.e., in the default positions, the field of view provided by the central mirror 84, and the other mirrors as well, is displaced downwardly with respect to the trailing vehicle 20, and depending upon the gradient of the incline 26 and the distance between the two vehicles, may completely miss the trailing vehicle 20.

Referring to FIG. 8, according to the present invention, as the vehicle 10 turns into incline 26, the vehicle 10 experiences a pitch r about the y-axis, which is detected by the turning sensor 50, and corresponding signals are sent to the control unit 60. In turn, the control unit 60 provides appropriate signals to the mirror driving means 70b to actuate the central side mirror 84 and rotate the same about the y-axis to shift the field of view by an angle β, thus compensating for the rotation of the vehicle 10 due to the change in the curvature from lane 25 to incline 26. This procedure enables the trailing vehicle 20 to once again fall fully in the field of view of the central mirror 84. Thus, the turning angle β1 is dependent on the change of slope β2 between the lane 25 and incline 26, or rather of the path taken by the vehicle 10.

Similarly, the control unit 60 also provides suitable signals to operate the side mirrors 82 and 84 which are also angularly displaced, typically by the same angle β1, providing a more central view of the trailing vehicle 20

Thus, as the vehicle 10 effectively rotates a rotation r about its y-axis while it is traveling from the lane 25 to incline 26, the mirrors 82, 84, 86 are also appropriately rotated to maintain the relative viewing angles for the driver as was the case before the turning commenced.

In practice, the vehicle 10 usually follows a smooth or curved path 27 between the lane 25 and incline 26, and as the vehicle is rotating about the y axis incrementally changing the pitch angle, appropriate input signals are provided to the control unit 60, and from this to the mirror driving means 70a, 70b, 70c to provide change in viewing angle β1. If the path of the vehicle up the incline 26 change in curvature or gradient, which may include going from a positive curvature to a negative curvature and/or gradient, such as for example when traveling along bumps or a hilly road, the turning sensor 50 will once again sense the change in the attitude of the vehicle with respect to the y-axis. Appropriate signals are once again sent to the mirror driving means 70a, 70b, 70c, to change rotate the mirrors 82, 84, 86 respectively about the y-axis in an appropriate manner. Further, when the vehicle reverts to a rectilinear path, even if this is along the incline, the mirror driving means 70a, 70b, 70c, actuate the mirrors to return each to its default position. In particular, the control unit 60 may be adapted to sense that the vehicle has been traveling for a predetermined amount of time or distance up or down along a steady incline, and in such a case returns the mirrors to the default positions to better view the road conditions. Thus, once the vehicle 10 has fully traveled into the incline, this may be treated as a level lane, and thus, the mirrors can return to the original default positions.

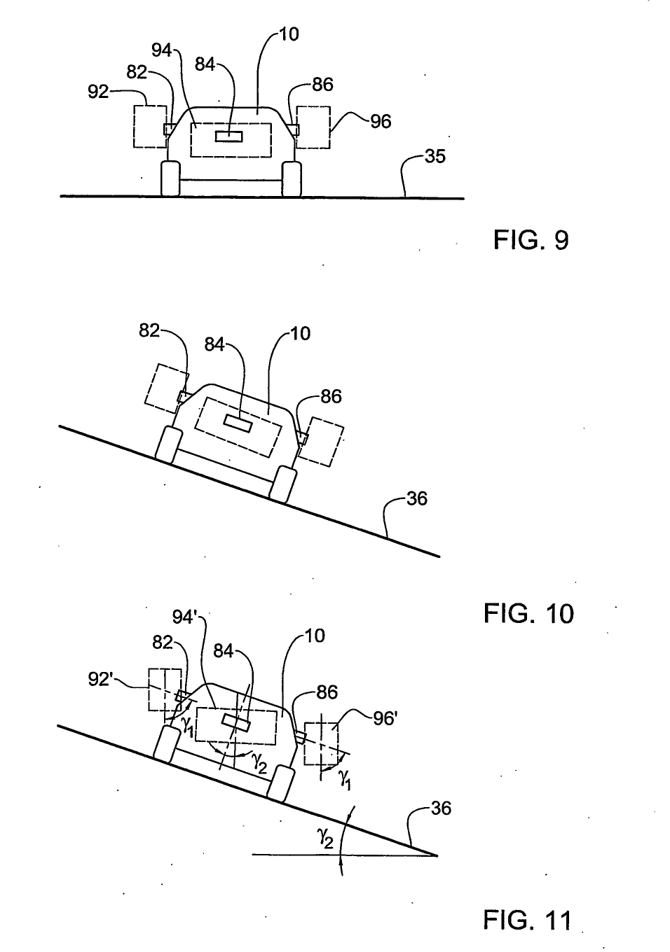

FIGS. 9 to 11 illustrate operation of the system 100 with reference to rolling turns about the x-axis when there is no turning of the vehicle about the other two axes.

FIG. 9 illustrates the rear side of a vehicle 10 traveling along a level road lane 35. The rear-view mirrors 82, 84, 86 are set up in the default positions such as to each provide a reasonable field of view, 92, 94, 96, respectively, of the scenery to the rear of the vehicle 10.

As illustrated in FIG. 10, as vehicle 10 turns in into bank 36, if the positions of the mirrors relative to the vehicle 10 are maintained statically, i.e., in the default positions, the field of view provided by the central mirror 84, and the other mirrors as well, is distorted with respect to the horizon.

Referring to FIG. 11, according to the present invention, as the vehicle 10 turns into bank 36, the vehicle 10 experiences a roll p about the x-axis, which is detected by the turning sensor 50, and corresponding input signals are sent to the control unit 60. In turn, the control unit 60 provides appropriate output control signals to the mirror driving means 70a, 70b, 70c to actuate the mirrors 82, 84, 86 respectively, and rotate the same about the x-axis to shift the field of view by an angle γ1 to 92′, 94′, 96′, respectively, thus compensating for the rotation of the vehicle 10 due to the change in the angle from lane 35 to bank 36. This procedure enables the driver of vehicle 10 to once again view the rear scenery adjusted to the horizon. Thus, the turning angle γ1 is dependent on the angle γ2 between the bank 36 and the horizon.

Thus, as the vehicle 10 effectively rotates a rotation p about its x-axis while it is traveling from the lane 35 to incline 36, the mirrors 82, 84, 86 are also appropriately rotated to maintain the relative viewing angles for the driver with respect to the horizon as was the case before the turning commenced.

If the attitude of the vehicle while traveling along the bank 36 changes in gradient, which may include going from a positive gradient to a negative gradient, such as for example when traveling along bumps or an s-shaped high speed highway, the turning sensor 50 will once again sense the change in the attitude of the vehicle with respect to the x-axis. Appropriate input signals are once again sent to the mirror driving means 70a, 70b, 70c, to change rotate the mirrors 82, 84, 86 about the z-axis in an appropriate manner.

When the vehicle continues to travel along a path where the bank angle γ1 is substantially constant, the control unit 60 may optionally command the mirror driving means 70a, 70b, 70c, to maintain the current positions. Alternatively, the control unit 60 may be adapted to sense that the vehicle has been traveling for a predetermined amount of time or distance along the bank, and in such a case returns the mirrors to the default positions to better view the road conditions. Thus, the latter case may be treated similarly to a level lane, and thus, the mirrors can return to the original default positions.

According to the invention, the system 100 is adapted to sense the road conditions by means of the turning sensor 50, i.e., to simultaneously detect the rotations of the vehicle about the x, y and z-axes. Further, the system 100 simultaneously provides actuation signals to the mirror driving means 70a, 70b, 70c so that each will be rotated about the x, y, and z axes as appropriate, each component rotation for each mirror being similar to that described for each rotational component herein, mutatis mutandis, to optimize the fields of view of each mirror as presented to the driver.

Thus, once the vehicle 10 has stopped turning about any of the axes x, y or z, and is now traveling along a fixed and different direction, for example North instead of West, and/or up a steady incline, and/or along a banking road, for example, and/or along a curve of constant radius, the rate of change of each of the corresponding component rotation angles p, q, r will be zero, though the absolute value of each angle with respect to an external coordinate system may have changed and may continue to change from the initial values before the turning maneuver commenced. In such cases, the angular dispositions of the mirrors may remain fixed until the vehicle starts to turn again about any of the axes x, y, z, or alternatively may revert to the default positions.

The changes in the magnitudes of the component rotational angles p, q, r are preferably updated at a relatively high frequency, which may be constant, or vary according to road conditions, for example, being in the range 2 to 300 Hz, typically 200 Hz, for example, and the updated rotational angles are input to the control unit 60, so that the positions of the mirrors 82, 84, 86 may be updated smoothly and substantially in a manner that may be perceived as continuous.

Optionally, the control unit 60 may also receive vehicle velocity input from the speedometer 45, to further refine calculation of the tilt angles required for each of the mirrors 82, 84, 86.

The system 100 preferably further comprises a user interface 40, which enables the user to control operation of the system 100. For example, the interface 40 comprises an on/off switch that enables the user to disconnect operation of the system 100, and thus enable the mirrors 82, 84, 86 to operate as regular statically mounted mirrors. An option may be provided by the interface 40, when switching off the system 100, to return the mirrors 82, 84, 86 to their default positions, or to maintain the mirrors oriented as they are at that point. The interface 40 may also allow operation of each mirror 82, 84, 86 to be separately switched off or on.

The interface 40 may optionally also have the capability of instructing the control unit 60 to provide suitable output signals to provide tilting one or more of the mirrors 82, 84, 86 about the y-axis, so that the field of view is lowered with respect to the horizon. Such a feature is useful for avoiding glare that may occur when driving with the back to a low sun, or when trailing vehicles have their headlamps on at full beam. A suitable switch on the interface 40 enables the user to select the mirror tilting mode feature. Optionally, the mirror tilting feature may be automated by providing a suitable photo-detector in the vicinity of one or more of the mirrors such as to detect the intensity of light incident on the mirrors. The photo detector may be operatively connected to the control unit 60, and when the intensity of light detected by the photo detector exceeds a predetermined threshold associated with glare, a suitable signal is sent to one or more of the mirror driving means 70a, 70b, 70c to tilt the mirrors by an appropriate amount. In this connection, the one or more of the mirror driving means 70a, 70b, 70c may continue to be tilted until the intensity of the light detected by the photo detector has reduced below the threshold. An option for overriding the automated mirror tilting feature may be provide in the interface 40, enabling the user to tilt the mirrors or to reverse the tilting so that the mirrors revert to their positions before tilting or to the default position. It should be mentioned that if the system is in operation before mirror tilting feature is used, the system 100 typically continues to adjust the mirrors 82, 84, 86 to compensate for the changing road conditions, and superimposing on this the required tilting of the mirrors. Thus, if under these circumstances the mirror tilting feature is deactivated, the mirrors adopt the appropriate orientations with respect to the x, y and z axes as determined by the control unit 60 from the appropriate input signals provided by the sensor 50.

The interface 40 may also be used to set up the default positions of the mirrors 82, 84, 86, and in fact sets of default positions may be stored in a suitable memory, wherein the different sets correspond to different drivers of the vehicle 10. Accordingly, the interface 40 may comprise a display, for example an LED display, by means of the user can be prompted for information. The display is operatively connected to a suitable microprocessor unit, which may the same as or a different one from that comprised in the control unit 60. If a new user wishes to input default positions, then the display prompts the user to input a unique identifier, which could comprise for example the user's name. Then, the user is asked which mirror is to be set up, and the user can choose between mirrors 82, 84, 86. When the mirror has been selected, the appropriate mirror is positioned to provide the desired orientation and field of view for the user sitting at the drivers seat. The positioning of the mirror may be manual, for example by manually moving the mirror to the required position. A suitable angular position sensing means and feedback to the control unit 60 and interface 40 is required to enable the position to be stored for future use. Alternatively, the positioning of the mirror may be accomplished in a powered manner, for example making use of the appropriate mirror driving means 70, and controlling the same via a joystick or other control input feature that is operatively connected to the mirror driving means 70, either directly or via the control unit 60 or interface 40. The procedure can then be repeated for the remaining mirrors. The user then has the option of saving the current setup to a suitable memory, and the user can recall the set up values for the default positions. A number of different users can store their respective set up values for the default position of the mirrors, and thus whenever a different one of these users is driving, the interface 40 allows the corresponding default positions to be set for the mirrors.

The interface 40 may further comprise a feature that enables the datum references of the turning sensor 50 to be set or reset. To use this feature, the vehicle is placed on a flat and level surface, and a suitable activator switch the current component angle values for p, q and r are set as the datum values for the vehicle.

The turning sensor 50 is preferably a three-axis sensor and may comprise any suitable configuration. While the sensor 50 may be located wherever convenient with respect to the vehicle 10, it is preferably mounted as close as possible to the centre of gravity thereof. Optionally, more than one sensor 50 may be mounted to the vehicle and operatively connected to the control unit 60. Optionally, the sensor 50 may comprise a plurality of sensing units each of which senses rotation about one axis of three mutually orthogonal axes.

The turning sensor 50 may be gyroscope based, for example, comprising three rotating gyroscopes, each turning about mutually orthogonal axes, and the gyroscopes may be mechanical gyroscopes, laser gyroscopes, optical gyroscopes or any other suitable gyroscopes. Suitable examples of such gyroscopes may include, for example, gyroscope sensors provided by Wuntronic GmbH, of Munich, Germany. The gyroscopic-based turning sensor 50 according to the invention is configured to provide turning angles p, q, r relative to the vehicles orthogonal axes x, y, z, rather than relative to an external fixed coordinate system. However, gyroscopes generally operate such as to maintain their orientation with respect to an external fixed coordinate system, or to provide a measure of angular deviation from such an external coordinate system. Accordingly, in the present invention, the gyroscope-based turning sensor 50 provides, for each of the component rotational angles p, q, r, in addition to absolute changes in angle, also the corresponding rates of rotation.

Accordingly, the control unit 60 receives signals relating to each of the component rotational angles p, q, r, which may thus contain data regarding the changes in absolute angles with respect to an external coordinate reference system, and also data about the rate at which the angle is changing and on the basis thereof generates suitable actuation signals which are transmitted to each of the driving means 70. This data is fed to the control unit 60, which preferably comprises a suitable microprocessor element that has been calibrated and programmed to provide appropriate signals to each of the driving means 70, to provide the changes in the field of view, for example as described herein.

Alternatively, the turning sensor 50 may comprise a three axis accelerometer and a three axis angular rate sensor, which may be used together to provide accurate data regarding the orientation of the vehicle with respect to the three axes x, y, z. In general, accelerometers allow the measurement of forces caused by a vehicle turning, accelerating or braking, but inaccuracies creep in when the vehicle is not level. Tilt sensors, on the other hand, can accurately measure the direction of gravity as a reference direction, but provide inaccurate angular measurements when the vehicle is turning, accelerating or braking. “Measurement of a Vehicle's Dynamic Motion” by Crossbow, the contents of which are incorporated herein in their entirety, discloses a system of angular rate sensors and accelerometers that provide accurate measurements of the dynamic motions of the vehicle.

Thus, for example, the angular rate sensors each measure the rate at which the vehicle rotates around the corresponding x, y and z axes. Each rate is integrated over time, and a turning angle with respect to each one of the x, y and z axes is obtained as a function of time. As result, an offset error in angular rate produces an error in angle, for each of yaw, pitch and roll, which increases linearly with time. Further, random noise in the rate sensors produces a random-walk effect in the calculated angle, causing the calculated angle to drift at a rate proportional to the square root of time, even when there is an absence of rate bias error. These limitations are overcome by using the rate sensors to measure angle changes on short time scales. The accelerometers are then used as tilt sensors to calculate the tilt angles, and the rate sensor derived angles for each of yaw, pitch and roll are forced to slowly match the corresponding accelerometer angles over a long time scale.

Essentially each rate sensor output is integrated in real time to find raw angles for pitch, yaw and roll. Each accelerometer is then used to measure the direction of gravity and to infer a tilt angle, given by
tilt angle=arcsine(n)

wherein n is the acceleration measured as a multiple of g, the acceleration due to gravity. Preferably, a low pass filter, such as single pole RC filter, with cutoff at 100 Hz may be used to avoid vibration and similar effects.

For each one of yaw, roll and pitch, the following procedure is adopted. First, the difference between the raw angle and the tilt angle is calculated, providing an error signal that is used to correct the angle calculation. The error signal is modified by a gain parameter k, which controls how much of the error signal is used to correct the rate sensor angles. Then, the raw angle is added to the error signal, providing a calculated angle, which is dominated in the short time scale domain by the rate sensor information, but corrected in the long time domain by the accelerator data. The time scale is set by the value of k. the value of k sets the time constant at which the rate sensor angle calculation is stabilized by the gravity angle calculation. The time constant is generally chosen to be longer than the expected maneuvers being tested, and this value is divided by the measurement rate to provide the value of k. For example, if a time constant of 2 seconds is required, and the accelerometers and rate sensors are measured at 100 Hz, then the value for k is 2/100, i.e. 0.02.

Where such an arrangement for the turning sensor 50 is used, the control unit optionally comprises a digital signal processor as part of the data acquisition system, to provide real-time results.

Optionally, a temperature sensor is used to provide temperature data to compensate for temperature effects in the accelerometer and rate sensor outputs.

Optionally, and preferably, the first embodiment is also adapted for enabling the user to rotate and pan one or more of the mirrors 82, 84, 86 about any axis, x, y or z, in response to a predetermined condition. Such panning enables the driver to scan and thus effectively temporarily expand the corresponding filed of view. One particularly useful application of the scanning capability is directed specifically to panning about the z-axis, and is useful for situations such as when the driver of vehicle 10 wishes to overtake a vehicle in front of it.

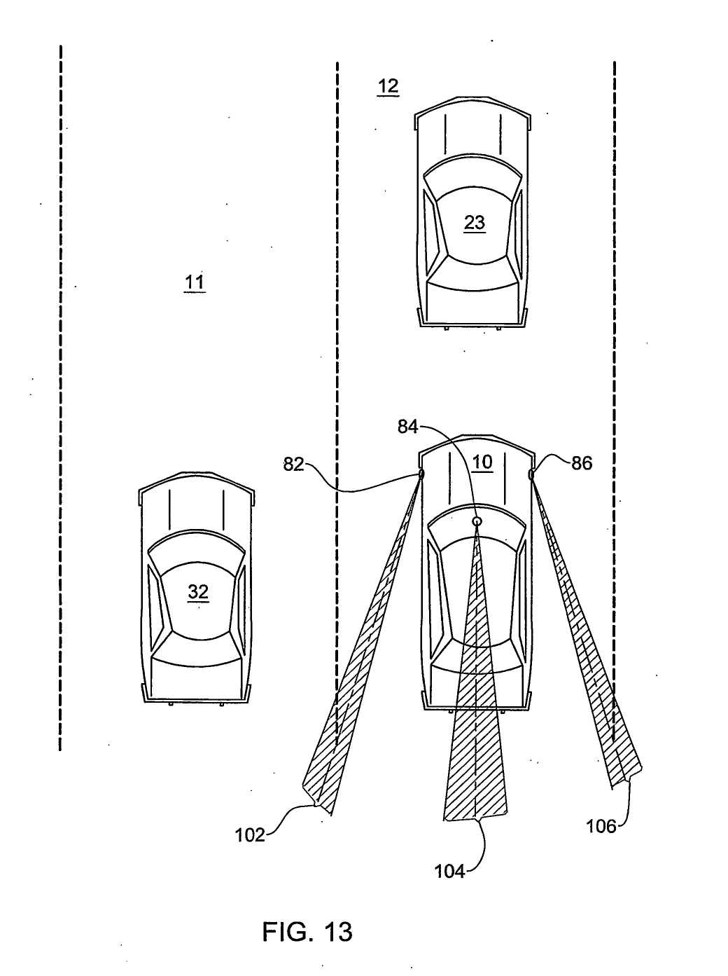

For example, and referring to FIG. 13, when the vehicle 10 traveling along lane 12 wishes to overtake vehicle 23 traveling ahead of it, or simply change lane, it must ensure that the left hand lane 11 is clear for this maneuver. Accordingly, the driver of vehicle 10 checks mirrors 82, 84, 86 to check the traffic situation to the side and rear of the vehicle 10. However, as illustrated in this figure, the mirrors 82, 83, 86, provide fields of view 102, 104 106, respectively, that do not provide full 180° cover of the sides and rear of the vehicle, leaving a number of some blind spots for the driver. In particular, the driver is unable to see via the left side mirror 82 another vehicle 32 that is ahead of the field of view 102 provided by this mirror. Accordingly, if the driver where to attempt the overtaking maneuver in such a situation, a collision could occur with vehicle 32. Responsible drivers therefore tend to check the full 180° field directly by turning their heads around, and thus momentarily, which also not risk-free since the driver's eyes are being turned away from the forward direction.

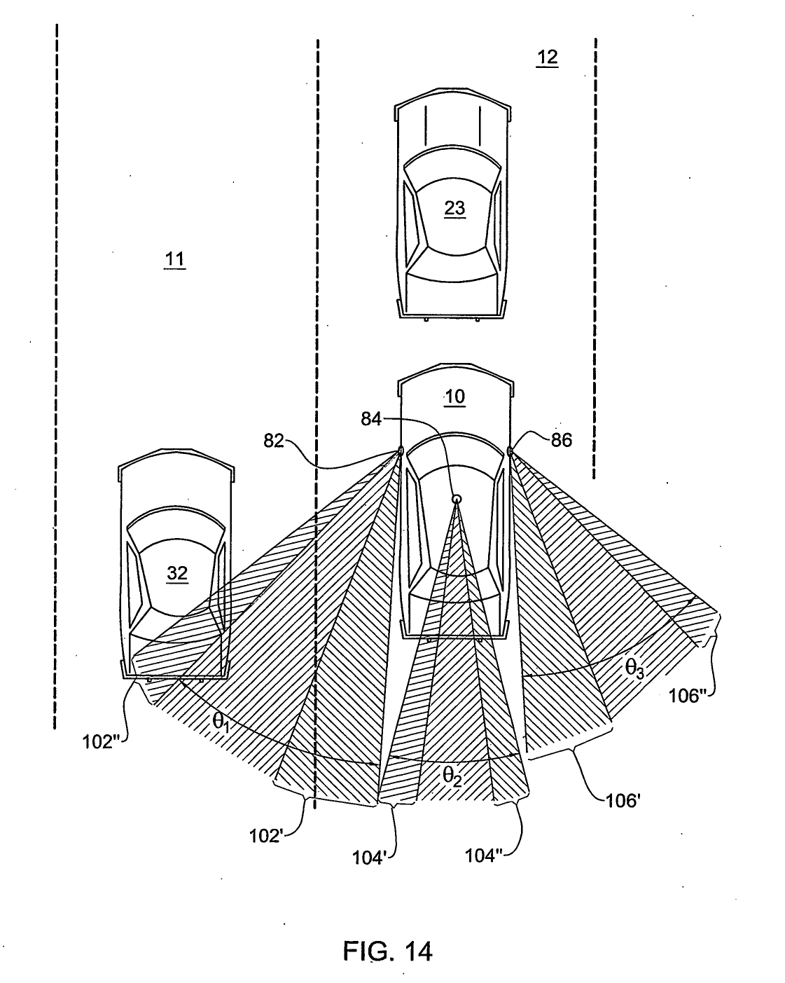

Referring to FIG. 14, the scanning feature of the present invention enables the mirrors 82, 83, 86, to be rotated about axis z through a suitable angular range such that the corresponding fields of view are considerably expanded. Thus, in one mode of operation, the mirror 82 on the driver's side is rotated about the z-axis to a zero position close to the vehicle 10 such that the mirror 82 captures in its field of view 102′ part of the vehicle's left side. Then the mirror 82 is rotated in an outboard direction about the z-axis about an angle θ1 such that preferably a part of the field of view 102″ at maximum pan is at 90° to the forward direction. Thus, effectively, the field of view has increased from 102 in FIG. 13 to the range 102′ to 102″ in FIG. 14, considerable expanding the view offered to the driver, without necessitating rearwards rotation of the driver's head. In a similar manner, mirrors 84 and 86 may optionally also be rotated about the z-axis through angles θ2 and θ3, respectively, to increase the fields of view 104, 106, respectively to 104′ to 104″, and 106′ to 106″, respectively. Accordingly, it is possible to present the driver with substantially a full 180° view of the sides and rear of the vehicle, though not all at the same time, so that the driver may check the same before deciding whether or not to proceed with the overtaking maneuver or changing lanes.

To operate the system 100 in scanning mode, the control unit 60 is configured to provide suitable signals to one or more of the mirror driving means 70a, 70b, 70c so that they rotate the corresponding mirrors 82, 83, 86, about a suitable predetermined arc, and at a predetermined angular turning rate. A suitable arc for mirror 82 may commence with a scan of, for example, −5° (i.e., in the inboard direction) to align the mirror with the x-axis, or whatever other value is necessary to rotate the mirror from its current position, which may be the default position or another position according to the attitude of the vehicle if the vehicle is also turning, for example. Then the mirror 82 is turned about 45° or possibly 40°, or even less, in an outboard direction, so that the field of view offered to the driver pans by angle θ1, preferably up to 90°. Similarly, mirror 86 may be rotated, first by −5° or another suitable angle inboard, and then by 45° or less in the outboard direction. The central mirror can be panned from its current position in a clockwise direction, and then anticlockwise direction to provide scanning angle θ2, which may be 90° or more. Suitable angular rates for each mirror preferably complete a full panning cycle for each mirror in 1-3 seconds, for example.

The scanning mode may be initiated in any one of a number of ways. For example, interface 40 may comprise a suitable control switch that enables the driver to selectively engage the scanning mode when desired. Such a control switch may be a simple on-off switch. Alternatively, the control switch may enable the user to scan only with the mirror of interest, and allow the user to choose between the three mirrors. For example, the user only wish to scan only with mirror 82 before initializing an overtaking/change lane maneuver, while he/she may wish to scan only with mirror 86 when attempting to re-enter lane 12 after vehicle 10 has passed vehicle 23.

Alternatively, the indicator circuit of the indicator switch of the vehicle 10 may be operatively connected to the control unit 60, so that when the indicator is turned on, the system 100 automatically begins a scan for some or all of the mirrors 82, 83, 86. In such a case, the control unit 60 may be configured to provide a full panning cycle for the mirrors every 30 seconds, for example, so long as the indicator is still activated. The control unit 60 may optionally be configured to pan only one or the other of mirrors 82 and 86 (and optionally also central mirror 84 in either case) depending on whether the indicator is indicating to the left or to the right, respectively. Preferably, the indicator is operatively connected to the control unit 60 via interface 40, so that the user has the option of turning off the scanning feature when desired, so that there is no scanning when indicating. For example, when parking the vehicle in a side parking, the driver may wish to have a fixed fled of view with respect to the vehicle 10.

Similarly, the system 100 may be configured to pan one or more of mirrors 82, 83, 86, about the x-axis and/or the y-axis in a similar manner to that described herein for the z-axis, mutatis mutandis.

When the scanning feature is in operation, the control unit 60 is typically configured to disregard input signals from the turning sensor 50 altogether, or at least with respect to the angle about which it is intended to scan. Preferably, though, the control unit 60 continues receiving input signals from the turning sensor 50 and determines the output signals for operating the driving means 70, but does not actually send the output signals thereto, or at least the output signal with respect to the turning angle about which it is intended to scan.

Thus, when the system 100 is commanded to provide scanning about the z-axis, the control unit 60 blocks the output signals to the driving means 70 (or simply may disregard the signals from the turning sensor 50) relating to motion of the vehicle about the z-axis, and rather provide suitable signals to the appropriate mirror driving means(s) 70 regarding the motion of the corresponding mirror(s) about the z-axis consistent with the panning rotation required. When the panning rotation is complete, the control unit 60 resumes receiving the full input signals from the sensor 50, and continues to adjust the mirror(s) as before.

While the first embodiment has been described with reference to dynamic angular motion of the vehicle with respect to the three axes x, y and z, other variations of this embodiment may be provided in which the rotational motion about only two axes are considered and used for adjusting the mirrors 82, 83, 86, for example about the x and y axes only (roll and pitch), x and z axes only (roll and yaw), or y and z axes only (pitch and yaw). In yet other variations of this embodiment, rotational motion about only a single axis is considered and used for adjusting the mirrors 82, 83, 86, for example about the x axis only (roll), y axis only (pitch) or z axis only (yaw). In each of these embodiment variations, the turning sensor 50 may be considerably simplified, only requiring to sense the rotations about the particular axis/axes of interest, and similarly, the mirror driving means 70 are similarly simplified to provide compensating motion to the mirror about the axis/axes of interest. Similarly, any of the above mentioned variations of the first embodiment may comprise the panning and scanning capability for one or more of the mirrors 82, 83, 86, about one or more of the axes x, y, z, in a similar manner to that described above for the first embodiment, mutates mutandis.

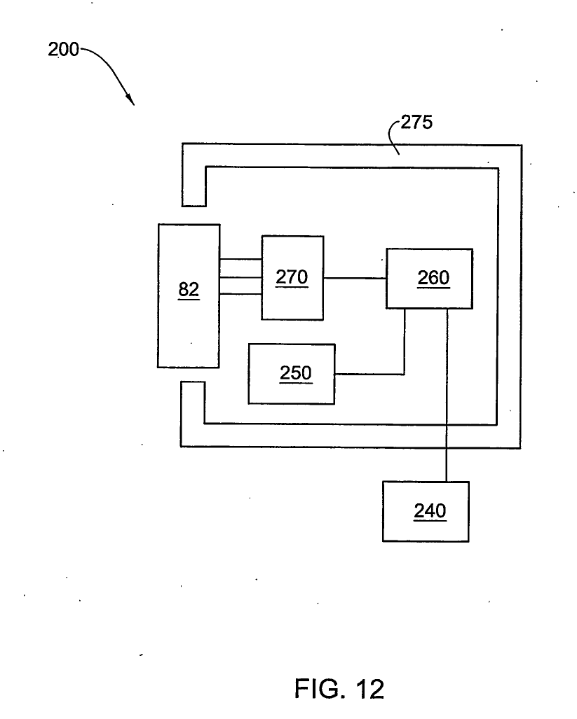

A second embodiment of the present invention, illustrated in FIG. 12, comprises all the elements and features as described with respect to the first embodiment or variations thereof, mutatis mutandis, with the following differences. In the second embodiment, the system 200 comprises a turning sensor 250, a control unit 260, and mirror driving means 270 similar to the turning sensor 50, a control unit 60, and mirror driving means 70 of the first embodiment, mutatis mutandis, except that the system 200 is configured to service a single mirror, 82, 84 or 86. Preferably, the turning sensor 250, a control unit 260, and mirror driving means 270 are housed in a mirror housing 275, and thus the system 200 can be fitted at each of the rear view mirror location as a separate stand-alone unit. This embodiment has the advantage of being readily retrofittable to existing vehicles with relatively little modification, typically no more than the electrical connection of the system 200 to the vehicle's power supply. Optionally, an interface 240 similar to that described for the first embodiment, mutatis mutandis, may also be provided, and this may be dedicated to each system 200, or serve a plurality of systems 200 corresponding to a plurality of mirrors for a vehicle.

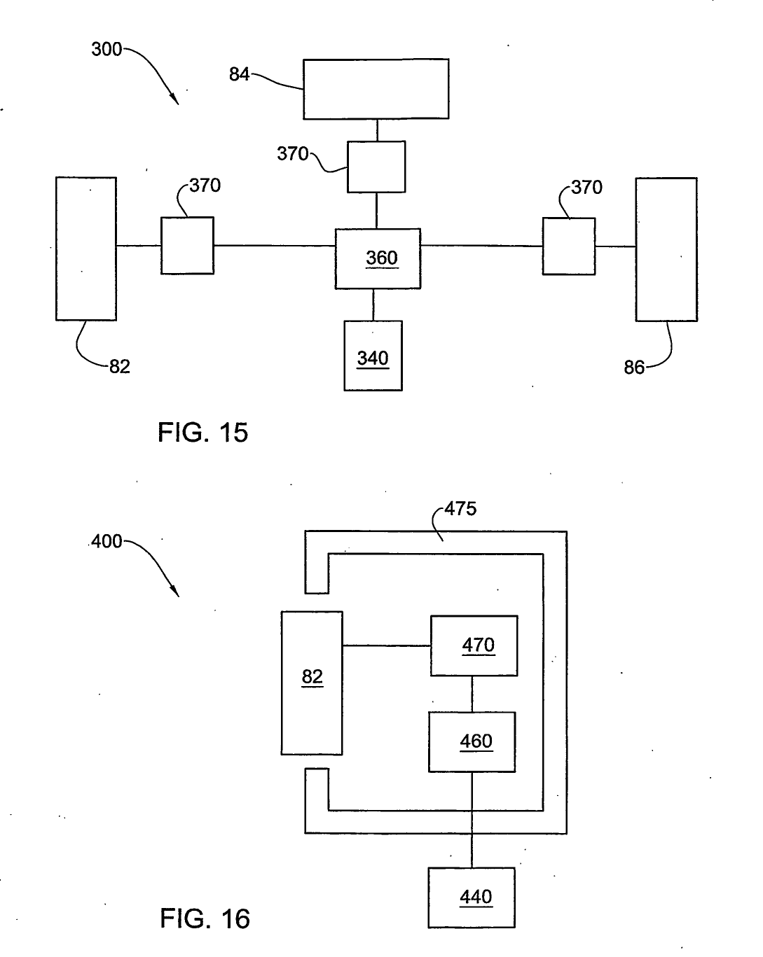

A third embodiment of the present invention, illustrated in FIG. 15, is directed at providing a panning movement, to one or more rear-view mirrors of a vehicle to enable scanning of the rear field of view by the user. The system 300 according to the third embodiment thus comprises all the elements and features as described with respect to the first embodiment or variations thereof, mutatis mutandis, with the following differences. In the third embodiment, the system 300 comprises a control unit 360, and mirror driving means 370 for each of the mirrors 82, 84, 86, similar to the control unit 60, and mirror driving means 70 of the first embodiment, mutatis mutandis, but does not require a turning sensor. Thus, the control unit 360 is adapted to provide panning rotations to the mirrors 82, 84, 86 in a similar manner to that described with respect to control unit 60, but does not provide signals to execute additional adjustments to the mirrors on account of yawing, rolling and/or pitching movements of the vehicle. The scanning mode may be initiated in any one of a number of ways, for example, as described for the first embodiment, mutatis mutandis, and thus the system 300 may optionally further comprise an interface 340 similar in form and function to interface 40 of the first embodiment.

A fourth embodiment of the present invention, illustrated in FIG. 16, is directed at providing a panning movement to a single rear-view mirrors of a vehicle to enable scanning of the rear field of view by the user. The system 400 according to the fourth embodiment thus comprises all the elements and features as described with respect to the second embodiment or variations thereof, mutatis mutandis, with the following differences. In the fourth embodiment, the system 400 comprises a control unit 460, and mirror driving means 470 for any one of the mirrors 82, 84, 86, say mirror 82, similar to the control unit 260, and mirror driving means 270 of the second embodiment, mutatis mutandis, but does not require a turning sensor. Thus, the control unit 460 is adapted to provide panning rotations to one of the mirrors, for example mirror 82 in a similar manner to that described with respect to control unit 260, but does not provide signals to execute adjustments to the mirror on account of yawing, rolling and/or pitching movements of the vehicle. The scanning mode may be initiated in any one of a number of ways, for example, as described for the first embodiment, mutatis mutandis, and thus the system 400 may optionally further comprise an interface 440 similar in form and function to interface 40 of the first embodiment. As with the second embodiment, the control unit 460 and mirror driving means 470 are optionally housed in a mirror housing 475, and thus the system 400 can be fitted at each of the rear view mirror location as a separate stand-alone unit. This embodiment also has the advantage of being readily retrofittable to existing vehicles with relatively little modification, typically no more than the electrical connection of the system 400 to the vehicle's power supply.

While there has been shown and disclosed exemplary embodiments in accordance with the invention, it will be appreciated that many changes may be made therein without departing from the spirit of the invention.

1-92. (canceled)

93. An automatic mirror position adjustment system for a vehicle, comprising:
a) at least one mirror movably mountable to said vehicle;
b) a turning sensor mountable to said vehicle and adapted for generating input signals responsive to rotations of said vehicle about at least two orthogonal axes;
c) a control unit operatively connected to said turning sensor and adapted for generating output signals responsive to said input signals;
d) a driving mechanism operatively connected to said control unit and coupled to the or each said at least one mirror for rotating the or each mirror about said at least two orthogonal axes in response to said output signals.

94. A system according to claim 93, wherein said turning sensor is adapted for generating input signals responsive to one of:
a) rolling and pitching rotations of said vehicle; or
b) yawing, pitching and rolling rotations of said vehicle.

95. A system according to claim 93, wherein said turning sensor is gyroscope-based.

96. A system according to claim 94, wherein said turning sensor comprises a accelerometer arrangement capable of measuring accelerations of said vehicle in said at least two axes coupled to an angular rate sensor arrangement capable of measuring rotation rate of said vehicle in said at least two axes.

97. A system according to claim 94, wherein said driving mechanism is adapted for rotating the or each mirror about in three orthogonal axes including said at least two axes.

98. A system according to claim 94, wherein said control unit is adapted to provide said output signals according to predetermined criteria.

99. A system according to claim 98, wherein said control unit provides said output signals to said driving mechanism such that said driving mechanism provides a rotation to said corresponding mirror in each said axis in directions opposed to the rotation of the said vehicle about each said axis, respectively.

100. A system according to claim 99, wherein said control unit is adapted for providing output signals to said driving mechanism for returning said at least one mirror to a default position that provides optimal fields of view to a driver of the vehicle when the vehicle is traveling along a straight and level path.

101. A system according to claim 99, wherein said control unit is adapted for providing output signals to said driving mechanism for pitching said at least one mirror to a position that provides optimal fields of view to a driver of the vehicle when the vehicle is traveling along an inclined path.

102. A system according to claim 99, wherein said control unit is adapted for providing output signals to said driving mechanism for rolling said at least one mirror to is traveling along a banked path.

103. A system according to claim 94, further comprising an interface unit operatively connected to said control unit, wherein said interface unit is adapted for instructing said control unit to provide output signals to said driving mechanism for returning said at least one mirror to a default position that provides optimal fields of view to a driver of the vehicle when the vehicle is traveling along a straight and level path.

104. A system according to claim 103, wherein said interface unit is adapted for setting and storing said default positions for a plurality of users.

105. A system according to claim 94, wherein said control unit is adapted for selectively providing output signals responsive to a predetermined input, wherein said driving mechanism to pan the or each mirror through a predetermined angular path about said at least one said axis in response to said output signals.

106. A system according to claim 105, wherein said angular path provides a yawing rotation to said at least one mirror.

107. A system according to claim 105, wherein angular path provides a visual scan of an effectively expanded field of view for a driver of said vehicle via a corresponding said mirror.

108. A system according to claim 106, wherein said angular path includes a rotation of a corresponding said mirror inboard towards said vehicle and outboard away from said vehicle.

109. A automatic mirror panning system for a vehicle, comprising:
a) at least one mirror movably mountable to said vehicle;
b) a control unit adapted for generating output signals responsive to a predetermined input signal;
c) a driving mechanism operatively connected to said control unit and coupled to the or each said at least one mirror for panning the or each mirror through a predetermined angular path about said at least one axis in response to said output signals.

110. A system according to claim 109, wherein angular path provides a visual scan of an effectively expanded field of view for a driver of said vehicle via a corresponding said mirror.

111. A system according to claim 109, wherein said predetermined input signal is provided via an interface unit operatively connected to said control unit,
wherein said interface unit is adapted for enabling a user to selectively activate or deactivate said system, and wherein said interface unit is further adapted for instructing said control unit to provide output signals to said driving mechanism for returning said at least one mirror to a default position that provides optimal fields of view to a driver of the vehicle when the vehicle is traveling along a straight and level path, when said system is deactivated.

112. An automatic mirror position adjustment method for a vehicle, comprising:
a) providing at least one mirror movably mountable to said vehicle;
b) sensing rotation of said vehicle about at least two orthogonal axes and generating input signals responsive to said rotation;
c) generating output signals responsive to said input signals;
d) rotating the or each mirror about said at least two orthogonal axes in response to said output signals.

113. A method according to claim 112, wherein said input signals are generated responsive to one of:
a) rolling and pitching rotations of said vehicle; or
b) yawing, pitching and rolling rotations of said vehicle.

114. A method according to claim 113, wherein said rotation is sensed via an accelerometer arrangement capable of measuring accelerations of said vehicle in said at least two axes coupled to an angular rate sensor arrangement capable of measuring rotation rate of said vehicle in said at least two axes, and wherein said accelerometer arrangement measures accelerations of said vehicle in three orthogonal axes including said at least two axes.

115. A method according to claim 114, wherein said angular rate sensor measures angular rate of said vehicle about three orthogonal axes including said at least two axes.

116. A method according to claim 115, further comprising the step of integrating angular rate about each axis provided by said angular rate sensor to provide raw angles about each axis, and inferring tilt angle about each axis from acceleration measurements provided by said accelerometer arrangement, and forcing the raw angles to match the tilt angles for each axis over a predetermined time period.

117. A method according to claim 113, comprising the step of rotating the or each mirror about three orthogonal axes including said at least two axes.

118. A method according to claim 113, wherein said output signals are provided according to predetermined criteria.

119. A method according to claim 118, wherein said mirror is rotated about each said axis in a direction opposed to the rotation of the said vehicle about each corresponding said axis, respectively, responsive to said output signals.

120. A method according to claim 113, further comprising selectively providing output signals responsive to a predetermined input, wherein the or each mirror is panned through a predetermined angular path about said at least one said axis in response to said output signals.

121. A method according to claim 120, wherein angular path provides a visual scan of an effectively expanded field of view for a driver of said vehicle via a corresponding said mirror.

122. A automatic mirror panning method for a vehicle, comprising:
a) at least one mirror movably mountable to said vehicle;
b) generating output signals responsive to a predetermined input signal;
c) panning the or each mirror through a predetermined angular path about said at least one axis in response to said output signals.

123. A method according to claim 122, wherein angular path provides a visual scan of an effectively expanded field of view for a driver of said vehicle via a corresponding said mirror.
